(19) United States
(12) Patent Application Publication
(10) Pub. No.: US 2022/0165522 A1
(43) Pub. Date: May 26, 2022

(54) Gas circuit breaker system and method thereof

(71) Applicant: TECHNOLOGIES MINDCORE INC., Terrebonne (CA)

(72) Inventors: Neil McCord, Terrebonne, QC (CA); Julien Rioux, Terrebonne, QC (CA); Louis-Philippe Gauvreau, Terrebonne, QC (CA); Renaud Grenier-Poulin, Terrebonne, QC (CA); Lahcen Mejjad, Terrebonne, QC (CA); Eric Renaud, Terrebonne, QC (CA); Jonathan Begin, Terrebonne, QC (CA); Jocelyn Ouellet, Terrebonne, QC (CA); Philippe Corriveau, Terrebonne, QC (CA); Patrick Lalonge, Terrebonne, QC (CA)

(21) Appl. No.: 17/456,132

(22) Filed: Nov. 22, 2021

Related U.S. Application Data
(60) Provisional application No. 63/116,650, filed on Nov. 20, 2020.

(51) Int. Cl. H01H 33/42; H01H 33/53; H01H 33/02

(52) U.S. Cl. CPC H01H 33/42; H01H 33/64; H01H 33/022; H01H 33/53

(57) ABSTRACT

The present invention concerns a gas insulated circuit breaker system. The system comprises a base station, an insulating column, a transition elbow and an interrupting chamber. With the placement of motion transferring mechanisms in the base station and the transition elbow, the system allows the opening and closing of the integrated circuit breaker within the interrupting chamber in a compact and efficient configuration from a link to an external control module in the base station.

### CROSS-REFERENCE TO RELATED APPLICATIONS

The present patent application claims the benefits of priority of commonly assigned American provisional Patent Application No. 63/116,650, entitled “GAS CIRCUIT BREAKER SYSTEM AND METHOD THEREOF” and filed at the United States Patent and Trademark Office on Nov. 20, 2020, the content of which is incorporated herein by reference.

### FIELD OF THE INVENTION

The present invention generally relates to the field of circuit breaker systems for power stations and/or distribution systems and to methods of operating the same. More specifically, the present invention relates to gas insulated circuit breaker systems and method of using the same.

### BACKGROUND OF THE INVENTION

Circuit breakers from low to high voltage applications are systems that may take a significant amount of space, be hard to setup and most often be dangerous to approach for maintenance employees, especially when installed in high voltage applications. A plurality of types of circuit breakers are already known for such applications, namely oil circuit breakers, vacuum circuit breakers, air circuit breakers and gas circuit breakers; each type having different pros and cons for various applications. It is to be noted that, among the different types of circuit breakers, the type with the fewer risks for high voltage applications is generally the gas circuit breaker. The gas circuit breaker may have different variations of circuit interrupting mechanisms, though most of them make use of the SF6 gas. An issue that may arise with gas circuit breakers is the multiple different mechanisms required to properly and safely close, manage, control and open the circuit. Accordingly, there is a need for an efficient gas insulated circuit breaker that is compact and safe to use.

### SUMMARY OF THE INVENTION

The aforesaid and other objectives of the present invention are realized by generally providing a gas insulated circuit breaker system. the system comprises a gas-filled interrupting chamber comprising a circuit breaker, a grounded insulating portion fluidly connected to the interrupting chamber and a circuit breaker controller to control opening and closing of the circuit breaker operable near the ground. The circuit breaker controller may be connected to the circuit breaker through the insulating portion. The circuit breaker controller is moveable into a first position and into a second position, the change from the first position into the second position opening or closing the circuit breaker.

The circuit breaker controller may comprise a connecting member connected at a first end to the circuit breaker and at a second end to a motion generator. The connecting member may comprise a lower connecting member moveable between the first and second positions within the insulating chamber. The connecting member may comprise a motion redirector changing a first motion of the lower connecting member into a second motion to displace a contact of the circuit breaker. The motion redirector may be a bell crank pivotally attached to the followings: about a first pivot point, the lower connecting member about a second pivot point, and the contact of the circuit breaker about a third pivot point. The motion redirector may further comprise a connecting member pivotally attached to the third pivot point and to the contact of the circuit breaker. The connecting member may be made with non-conducting material.

The circuit breaker controller may comprise a motion generator connected to the connecting member. The motion generator may comprise a pivoting link attached to the connecting member, pivoting the pivoting link moving the circuit breaker controller into the first and the second positions.

The insulating portion may be made with non-conducting material. The system may comprise a gas control system. The system may comprise a connecting chamber in fluid communication with the interrupting chamber and the insulating portion. The connecting chamber may form an angle of about 90 degrees between the insulating portion and the interrupting chamber. The insulating portion may be hollow. The system may be configured to be transported on a transport vehicle.

In another aspect of the invention, an assembly of gas insulated circuit breaker systems is provided. The assembly comprises at least two gas insulated circuit breaker systems, the assembly comprising a synchronizing system connected between the circuit breaker controllers of each of the at least two of the gas insulated circuit breaker systems.

The synchronizing system may comprise a rotating shaft connecting the circuit breaker controller of one of the at least two of the gas insulated circuit breaker systems and to the circuit breaker controller of another one of the at least two of the gas insulated circuit breaker systems. The synchronizing system may be activated and controlled by an external control system. The synchronizing system may comprise a rotating shaft having yoke ends, the yoke ends each being connected to a U-joint fixed to the circuit breaker controller of another of the at least two gas insulated circuit breaker systems. The synchronizing system may modify motion received from the circuit breaker controller of a first of the two of the plurality of circuit breaker systems to which it is connected to into another motion for the circuit breaker controller of a second of the two of the plurality of circuit breaker systems to which it is connected to.

In another aspect of the invention, a method to operate a circuit breaker system near electrical ground is provided. The method comprises inducing a first motion to a mechanical member near electrical ground, the mechanical member being made of non-conductive material, the first motion opening or closing the circuit breaker.

The method may further comprise a longitudinal axis of the insulated portion being at an angle with the circuit breaker, the method further comprising redirecting the first motion into a second motion being substantially parallel to the circuit breaker. The method may further comprise rotating a circuit breaker controller at a section or extremity of the insulated portion near the electrical ground and the rotation inducing the first motion to the mechanical member. The method may further comprise the first motion pivoting a link connected to the circuit breaker, the pivoting of the link inducing the second motion.

In another aspect of the invention, a method for safely operating a circuit breaker controller is provided. The method comprises inducing a first motion to a mechanical member made of non-conductive material along an axis of an insulated portion, the insulated portion housing the circuit breaker controller and the first motion being induced at a location free from electrical current.

The method may further comprise redirecting the first motion into a second motion at an angle from the axis of the insulated portion. The angle may be substantially perpendicular to the axis of the insulated portion. The method may further comprise: rotating the circuit breaker controller to induce the first motion to the mechanical member. The method may further comprise the first motion pivoting a link connected to the mechanical member to induce the second motion.

In another aspect of the invention, a monitoring system for a gas insulated circuit breaker is provided. The system comprises a gas-filled interrupting chamber for receiving a circuit breaker, a grounded insulating portion fluidly connected to the interrupting chamber and a monitoring system near the electrical ground, the monitoring system being in gas communication with the insulating portion.

The monitoring system may comprise a sensor for measuring characteristics of the gas. The monitoring system may comprise an optical fiber extending through the insulating portion. The optical fiber may comprise one or more sensors in data communication with the monitoring system.

The features of the present invention which are believed to be novel are set forth with particularity in the appended claims.

### BRIEF DESCRIPTION OF THE DRAWINGS

The above and other objects, features and advantages of the invention will become more readily apparent from the following description, reference being made to the accompanying drawings in which:

FIG. 1 is a front elevation view of a gas insulated circuit breaker system in accordance with the principles of the present invention.

FIG. 2 is a side elevation view of the gas insulated circuit breaker system of FIG.

FIG. 3 is a sectional elevation view A-A of the gas insulated circuit breaker system of FIG. 2.

FIG. 4 is a top plan view of three gas insulated circuit breaker systems in accordance with the principles of the present invention shown as synchronously operatively connected.

### DETAILED DESCRIPTION OF THE PREFERRED EMBODIMENT

A novel gas insulated circuit breaker system and method thereof will be described hereinafter. Although the invention is described in terms of specific illustrative embodiment(s), it is to be understood that the embodiment(s) described herein are by way of example only and that the scope of the invention is not intended to be limited thereby.

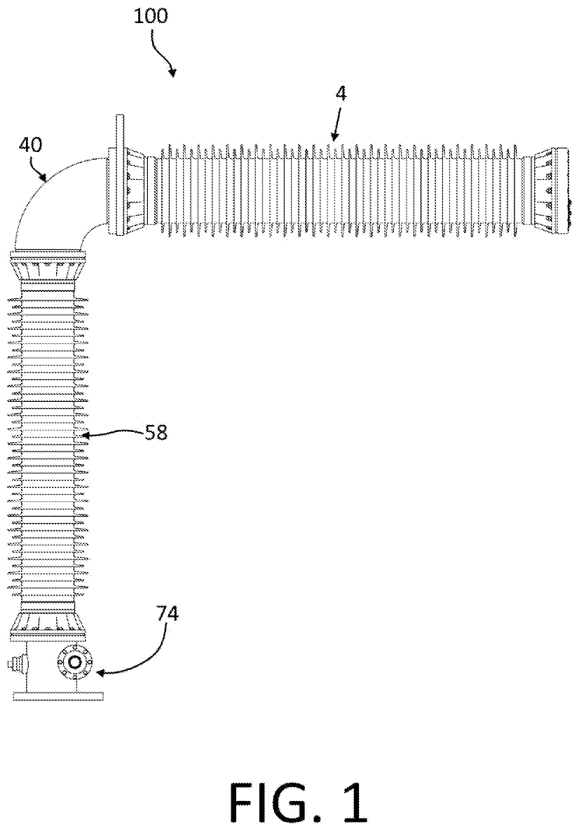

Referring to FIGS. 1 to 3, a circuit breaker system 100 is illustrated. The circuit breaker 100 is typically used with electric grids, distributions systems and power utility installations. In some embodiments, the circuit breaker system 100 is serially connected to a disconnector switch (not shown).

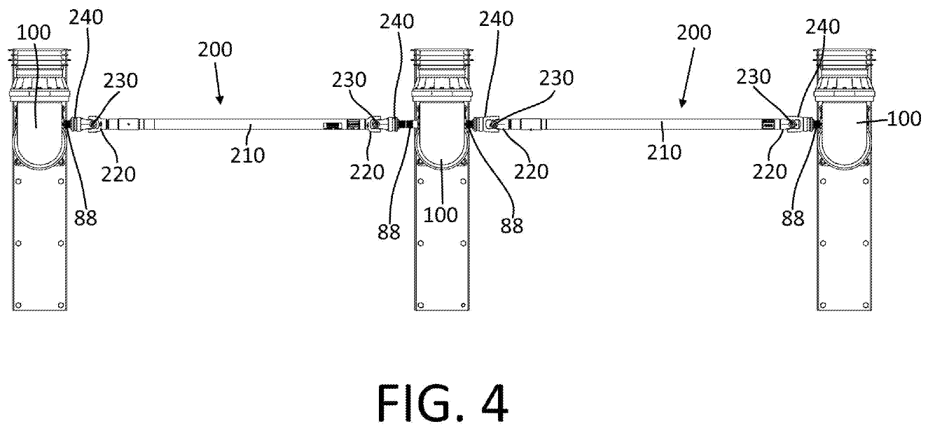

The system of FIGS. 1 to 3 is a gas insulated circuit breaker system 100 for usage in low to high voltage applications. In an embodiment, the insulated circuit breaker 100 comprises an operating system 90, an interrupting chamber 4 comprising a circuit breaker 24, a grounded insulated portion 58 connected to the interrupting chamber 4 using a connecting portion 40, a remote operating system 200, shown in FIG. 4, and a base portion 74.

Broadly, the circuit breaker system 100 is adapted to control the operations of the circuit breaker 24 from a distance using the operating station 74. In a preferred embodiment, the operating station 74 is adjacent or near a neutral connector, thus at the base of the insulated portion 58. The remote operating system 200 generally allows operating the circuit breaker 24 by transposing a movement along the axis of the isolated portion 58 to a movement along the axis of the interrupting chamber 4. In some embodiments, the isolated portion 58 is vertically positioned and the interrupting chamber 4 is horizontally positioned. In such embodiments the connecting portion 40 is an elbow forming an angle of about 90 degrees. Understandably, the insulated portion 58 and the interrupting chamber 4 may have any angle relative to one another.

In the present embodiment, the interrupting chamber 4 and the insulated portion 58 have a substantially hollow shape allowing the installation of various elements inside the chamber 4 and insulated portion 58 and allowing the passage of gas. Thus, the insulated portion 58 and the chamber 4 are in fluid communication allowing the gas to circulate between the insulated portion 58 and the chamber 4. In some embodiments, the two sections (4, 58) may be further covered with an insulating threaded surface (8, 62). The insulating threaded surface (8, 62) generally aims at dissipating heat present in the system 100. Each of the sections may be hermetically or sealingly connected to another section. In some embodiments, the sections are hermetically connected to one another using fastening members, such as high torque nuts and bolts, and a sealing means, such as a rubber seal.

As such, the voltage present in the gas in the chamber or in the connecting member 40 is high, such as about 145 kV. In the present embodiment, the base 80 of the insulated portion 58 is grounded, thus the voltage is at 0V or about 0V. Understandably, in other embodiments, the grounded portion of the insulated portion 58 could be positioned elsewhere than at the base 80. As such, an operator may control the opening and closing of the breaker where the insulated portion 58 is grounded, thus greatly limiting the potential accidents.

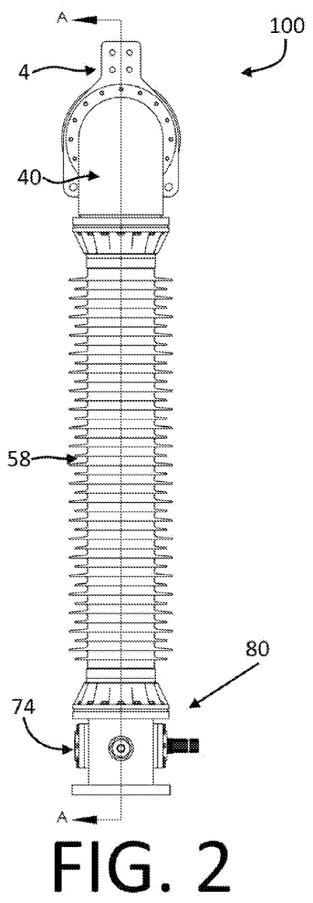

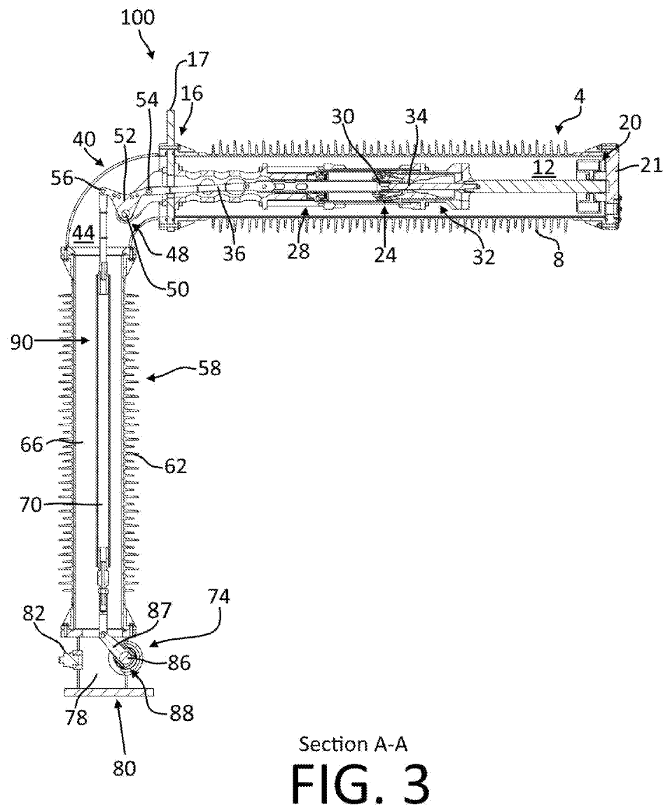

Now referring to FIG. 3, a sectional view along the axis A-A of the circuit breaker 100 of FIG. 2 is illustrated. The interrupting chamber 4 comprises two terminal pads (17, 21), typically at each end 16 and 20 of the interrupting chamber 4, respectively. The terminal pads (17, 21) are generally made of a conductive material adapted to withstand a maximum desired current level. The interrupting chamber comprises a first input pad 17, typically at the extremity 20 of the chamber 4 and a second output pad 21, typically at the second extremity 16 of the chamber 4. The terminal pads (17, 21) may have any shape known in the art and may be made of any conductive material known in the art.

The chamber 4 further comprises a gas circuit breaker 24 in electric communication with the first and second terminal pads (17, 21). In the illustrated embodiment, the type of circuit breaker used is a puffer type circuit breaker 24. In other embodiments, any other type of circuit breaker, such as gas circuit breakers, and more specifically such as a self-blast type circuit breaker, may be used. The interrupting chamber 4 is thus generally configured to conduct electrical current from the first terminal pad 17 to the second terminal pad 21 of said interrupting chamber 4 through the closed-circuit breaker 24.

The circuit breaker 24 of the illustrated embodiment comprises two sections, a first section 32 comprising a fixed contact 34 and a second section 28 comprising a displaceable contact 30. In the illustrated embodiment, the displaceable contact 30 is a female contact 30. The said female contact 30 is moved to cover and to contact with the fixed contact 34 when the circuit is closed. The circuit breaker 24 is thus generally adapted to conduct electrical current from the first section 28 to the second section 32 comprising the fixed contact 34. The circuit breaker 24 further comprises a movable contact or linking member 30. The linking member 30 is generally configured to be in operative connection with the remote operating system 200. Usually, the remote operating system 200 activates the operating system 90. When the operating system 90 is activated, the contact 30 is moved towards or away from the fixed contact 34, thus closing or opening the circuit. The contact 30 is generally adapted to move along the chamber 4, thus typically along a horizontal axis.

The operating system 90 generally links the remote operating system 200 to the circuit breaker 24 through the insulated portion 58, the connecting member 40, the base portion 74 and the interrupting chamber 4. The operating system 90 is generally made of non-conductive material to ensure that the current does not reach the neutral portion and/or the operating station 74. In some embodiments, the operating system comprises a connecting member 70 and a direction-changing mechanism 48. The direction-changing mechanism 48 is adapted to change movement of the connecting member 70, typically vertical movement, to move the contact 30 along the axis of the chamber 4. The direction-changing mechanism 48 is generally positioned within the connecting portion 40.

In some embodiments, the direction-changing mechanism 48 is embodied as a pivoting linkage mechanism. Referring to FIG. 3, the illustrated embodiment of the direction-changing mechanism 48 is a “bell crank” mechanism. The bell crank mechanism is adapted to translate a motion along a first axis to a motion along a second axis, typically at an angle of the first axis. In the illustrated embodiment, the angle is about 90 degrees. The “bell crank” mechanism 48 comprises a linking member 52 pivotally attached to the system 100 about a first pivot point 50. The pivot point 50 is typically horizontally positioned about the center of the width of the linking member 52. The linking member 52 is pivotally connected to a lower connecting member 70 about a second pivot point 56. The linking member 52 is further pivotally connected to the contact 30 or to a linking member 36 about a third pivot point 54. Understandably, any other type of direction-changing mechanism for translating a first motion along a first axis to second motion along a second axis may be used within the scope of the present invention.

In some embodiments, the contact 30 is linked to a connecting member 36, such as but not limited to a rod. In such embodiments, the connecting member 36 is further pivotally connected to the direction-changing mechanism 48. The connecting member may further be pivotally connected to the contact 30.

The interrupting chamber 4 is typically filled up with gas. The gas generally aims at quenching electrical arcs produced when the circuit breaker 24 is opened. The insulated portion 58 may further be filled with gas as the said portion 58 is in communication with the inner section 12 of the interrupting chamber 4. The gas also fills the circuit breaker 24 itself and any other portions of the system 100 in fluid communication with the interrupting chamber 4. In a preferred embodiment, the gas used is sulfur hexafluoride (SF₆). Understandably, any other suitable gas may be used within the scope of the present invention.

Still referring to FIG. 3, the connecting portion 40 is generally adapted be in fluid communication or be connected to the interrupting chamber 4 and to the insulated portion 58. In some embodiments, the connecting portion 40 is a transition elbow, as illustrated in FIGS. 1 to 3. In the embodiment illustrated at FIG. 3, the connecting portion 40 substantially forms a 90-degree angle from a first extremity to a second extremity. One skilled in the art shall understand that any other shape or angle may be used for connecting the interrupting chamber 4 to the insulated portion 58. In some embodiments, there may be more than one connecting portion 40 connecting the insulated portion 58 to the interrupting chamber 4. Gas may flow within the connecting portion 40, such as around the direction-changing mechanism 48 and in a hollow section 44 of the connecting portion 40. Thus, the gas may flow from the interrupting chamber 4 to the insulated portion 58 and/or vice-versa.

Still referring to FIG. 3, the insulated portion 58 is adapted to connect the connecting portion 40 to the operating station 74. The insulated portion 58 may also be in fluid communication with the connecting portion 40. In a preferred embodiment, the movement transferring rod 70 is hosted within the insulated portion 58. The movement transferring rod 70 is operatively connected to the operating station 74. The operating station 74 provides movement which is transferred to the connecting member 70. Similarly to the connecting portion 40 and the interrupting chamber 4, gas may flow within a hollow section 66 of the insulated portion 58. The gas may further flow around the movement transferring rod 70, from the operating station 74 to the connecting portion 40 and/or vice-versa.

The operating station 74 generally comprises an inner or hollow area 78 in fluid communication with the inner area 66 of the insulated portion 58. The operating station 74 generally allows to control the circuit breaker 24 at a location where the voltage in the gas is near 0V or at ground level through the circuit breaker operating system 90. Thus, the user is typically at a safe distance from zones comprising high-voltage. The operating station 74 is typically located adjacent or near the neutral/ground connector. As explained above, as the operating system 90 is made of non-conductive material, the operating station 74 is isolated from the voltage found within the circuit breaker 24. The operating station 74 is further configured to be fixed to any surface or system suitable for supporting the system 100. The operating station 74 may comprises a gas monitoring system 82 in fluid connection to the inner area 78 of the base station 74. The gas monitoring system 82 may further comprise a nozzle adapted to be connected to any sensor or equipment adapted to monitor the gas within the system 100. In some embodiments, the nozzle may further be used to add or remove gas from the system 100.

One of the benefits of the present invention is the presence of the gas monitoring system 82 near or at the grounded portion of the insulated portion 58. As the voltage present in the gas of the base 80 of the insulated portion 58 is 0V or about 0V, any sensor or monitoring device may be used. Indeed, the use of powered sensors or monitoring devices in gas comprising a high voltage is impossible without affecting the measurements or the operations/integrity of the sensor or monitoring device.

In yet other embodiments, the gas monitoring system 82 may comprise any type of sensor or capturing device to take measurements about the gas density, the gas pressure, humidity ratio of the gas or any other gas related measurements.

In further embodiments, optical fibers may be inserted in the gas insulated portion 58 toward the chamber to obtain any type of measurements within the gas having a high voltage. The optical fibers may further comprise sensors or micro-sensors allowing to take measures within an electric isolated environment, such as temperatures, etc.

The operating station 74 further comprises a control member 88 adapted to open or close the circuit breaker 24 with the operating system 90. In some embodiments, the control member 88 comprises a pivoting link 87. The pivoting link 87 is pivotally connected to the connecting member 70 and is fixedly attached to a rotating member 86. When the rotating member 86 is rotated, the connecting member 70 is moved about the axis of the insulated portion 58 as result of the movement of the pivoting link 87. In the illustrated embodiment, the insulated portion 58 being vertically positioned, the movement of the connecting member 70 is substantially vertical.

In further embodiments, the rotating member 86 may be operatively connected to an external control module 200 or automated rotating system, not shown, to automate the operations of the circuit breaker 24. In the illustrated embodiment, the angle of rotation of the pivoting link 87 is limited to under 180 degrees and allows the connecting member 70 to be moved in a substantially up or down motion. The angle of rotation of the pivoting link 87 may yet be limited to any other angle possible in a given embodiment as it may, for example, be limited to under 90 degrees only. Understandably, any other mechanism to transfer motion from the external control system 200 to the connecting member 70 may be used within the scope of the present invention.

The embodied system 100 of FIGS. 1 to 3 is configured to, when coupled to an external control module 200, open or close the circuit breaker 24 located within the interrupting chamber 4 which may create an open or closed circuit. It may be understood that, in some embodiments, the input and output terminal pads 17, 21 of the interrupting chamber 4 may further be coupled to other external systems, such as another interrupting chamber in accordance with the principles of the invention or to a disconnector.

In some embodiments, a plurality of gas insulated circuit breaker systems 100 may be connected in parallel, typically to allow a multi-phase current, such as but not limited to tri-phase current power distribution. In such systems, it is often desirable to synchronize the operations of the circuit breaker 24 of each of the systems 100. In such embodiments, the control member 88 of the operating station 74 of each of the systems 100 may be operatively connected to be synchronized. As such, when a circuit breaker 24 is opened, the control member 88 is rotated which operatively rotates the control members 88 of the other systems 100. Also, the control members 88 may be operated at the same time to synchronously trigger the opening or closing of the circuit breakers 24. In yet other embodiments, the opening or closing of the circuit breakers 24 may be controlled using one or more external control modules 200 operatively connected to all of the control members 88 of each system 100.

Now referring to FIG. 4, an embodiment comprising three gas insulated circuit breaker systems 100 synchronously connected is illustrated. In such embodiment, the operation of one system 100 may be synchronized to the one or more directly or indirectly connected systems 100. Each system 100 is connected to at least another system 100 using a synchronizing system 200. In such an embodiment, the control member 88 is embodied as a rotating shaft, such as a power take off (PTO) mechanism. In embodiment using PTOs, the synchronizing system 200 comprises a rotating shaft 210 having two ends 220. Each end 220 of the rotating shaft 210 is typically embodied as a yoke. The first end 220 is connected a connecting extremity 230 of the PTO, typically embodied as a U-joint. The second end 220 of the shaft 210 is connected to a second connecting extremity 240 of the control member 88 of a second system 100. The control member 88 may comprise a flange yoke 240 mating with the second connecting extremity 240.

In use, the control member 88 may be rotated, either manually or automatically, which transfer the rotation movement of the control member 88 to other control member 88 of the second and third systems 100, as illustrated. Thus, when a circuit breaker is opened, the circuit breakers 24 of the other systems 100 are also opened as the rotation movement of the control member 88 of the system 100 having an opening breaker 24 translates the rotation to the control members 88 of the synchronized systems 100.

It may be understood that any other known system to transfer rotation or movement in a synchronous manner may be used within the scope of the present invention. It may further be appreciated that, a control system (not shown) may be operatively connected to the synchronizing system 200 to automatically control the operation of the circuit breakers 24 of the system 100 in a synchronous manner.

In some embodiments, the control member 88 may transfer motion from a first synchronizing system 200 to a second synchronizing system 200 either directly or with modifications to the initial received movement. By modifying the mechanism of the control member 88, the torque might be modified, the rotational speed might be modified, the type of movement might be changed, or a phase shifting may be applied.

In some embodiments, the structural parts of the system 100 are made of material resisting to high temperature and pressure. In some embodiments, the insulating materials are ceramic, such as porcelain. The system 100 may be sized accordingly to the electrical range to conduct and/or answer to the special needs of a specific installation. In some embodiments, the system 100 may be transported, as is, on a transport vehicle and may be installed without significant use of heavy machinery.

In yet other embodiments, a motorized system (not shown) may be fixed to a rotating shaft 210. The motorized system is adapted to rotate the shaft 210 to generate a rotational motion. In such embodiments, the motorized system may be in communication with a controller, not shown, configured to request pivoting movement of the shaft 210 to control the operations of the circuit breaker 24.

A method of safely open or closing a circuit breaker is provided. The method comprises providing a first motion to a mechanical member made of non-conductive material along an axis of the insulated portion 58, the insulated portion having an extremity at a distance from the circuit breaker. The method further comprises changing the direction of the movement to a second motion at an angle with the first motion, the second motion opening or closing the circuit breaker 24. The method may further comprise the second motion engaging or disengaging a contact or connector in the circuit breaker 24. The method may also comprise rotating a control member 200 to create the first motion. The method may further comprise using a direction-changing mechanism 48 to transpose the first motion into the second motion.

While illustrative and presently preferred embodiment(s) of the invention have been described in detail hereinabove, it is to be understood that the inventive concepts may be otherwise variously embodied and employed and that the appended claims are intended to be construed to include such variations except insofar as limited by the prior art.

1) A gas insulated circuit breaker system, the system comprising:
a gas-filled interrupting chamber comprising a circuit breaker;
a grounded insulating portion fluidly connected to the interrupting chamber; and
a circuit breaker controller to control opening and closing of the circuit breaker operable near the ground, the circuit breaker controller being connected to the circuit breaker through the insulating portion, the circuit breaker controller being moveable into a first position and into a second position, the change from the first position into the second position opening or closing the circuit breaker.

2) The gas insulated circuit breaker system of claim 1, the circuit breaker controller comprising a connecting member connected at a first end to the circuit breaker and at a second end to a motion generator.

3) The gas insulated circuit breaker system of claim 2, the connecting member comprising a lower connecting member moveable between the first and second positions within the insulating chamber.

4) The gas insulated circuit breaker system of claim 3, the connecting member comprising a motion redirector changing a first motion of the lower connecting member into a second motion to displace a contact of the circuit breaker.

5) The gas insulated circuit breaker system of claim 4, the motion redirector being a bell crank pivotally attached to the followings:
about a first pivot point;
the lower connecting member about a second pivot point; and
the contact of the circuit breaker about a third pivot point.

6) The gas insulated circuit breaker system of claim 5, the motion redirector further comprising a connecting member pivotally attached to the third pivot point and to the contact of the circuit breaker.

7) The gas insulated circuit breaker system of claim 2, the connecting member being made with non-conducting material.

8) The gas insulated circuit breaker system of claim 2, the circuit breaker controller comprising a motion generator connected to the connecting member.

9) The gas insulated circuit breaker system of claim 8, the motion generator comprising a pivoting link attached to the connecting member, pivoting the pivoting link moving the circuit breaker controller into the first and the second positions.

10) The gas insulated circuit breaker system of claim 1, the insulating portion being made with non-conducting material.

11) The gas insulated circuit breaker system of claim 1, the system comprising a gas control system.

12) The gas insulated circuit breaker system of claim 1, the system comprising a connecting chamber in fluid communication with the interrupting chamber and the insulating portion.

13) The gas insulated breaker system of claim 12, the connecting chamber forming an angle of about 90 degrees between the insulating portion and the interrupting chamber.

14) The gas insulated breaker system of claim 1, the insulating portion being hollow.

15) The gas insulated circuit breaker system of claim 1, the system being configured to be transported on a transport vehicle.

16) An assembly of gas insulated circuit breaker systems, the assembly comprising at least two gas insulated circuit breaker systems according to claim 1, the assembly comprising a synchronizing system connected between the circuit breaker controllers of each of the at least two of the gas insulated circuit breaker systems.

17) The assembly of gas insulated circuit breaker systems of claim 16, the synchronizing system comprising a rotating shaft connecting the circuit breaker controller of one of the at least two of the gas insulated circuit breaker systems and to the circuit breaker controller of another one of the at least two of the gas insulated circuit breaker systems.

18) The assembly of gas insulated circuit breaker systems of claim 16, the synchronizing system being activated and controlled by an external control system.

19) The assembly of gas insulated circuit breaker systems of claim 16, the synchronizing system comprising a rotating shaft having yoke ends, the yoke ends each being connected to a U-joint fixed to the circuit breaker controller of another of the at least two gas insulated circuit breaker systems.

20) The assembly of gas insulated circuit breaker systems of claim 16, the synchronizing system modifying motion received from the circuit breaker controller of a first of the two of the plurality of circuit breaker systems to which it is connected to into another motion for the circuit breaker controller of a second of the two of the plurality of circuit breaker systems to which it is connected to.

21) A method to operate a circuit breaker system near electrical ground, the method comprising:
inducing a first motion to a mechanical member near electrical ground, the mechanical member being made of non-conductive material, the first motion opening or closing the circuit breaker.

22) The method of claim 21, the method further comprising a longitudinal axis of the insulated portion being at an angle with the circuit breaker, the method further comprising redirecting the first motion into a second motion being substantially parallel to the circuit breaker.

23) The method of claim 21, the method further comprising:
rotating a circuit breaker controller at a section of the insulated portion near the electrical ground; and
the rotation inducing the first motion to the mechanical member.

24) The method of claim 22, the method further comprising:
the first motion pivoting a link connected to the circuit breaker;
the pivoting of the link inducing the second motion.

25) The method of claim 21, the method further comprising redirecting the first motion into a second motion at an angle from the axis of the insulated portion.

26) The method of claim 25, the angle being substantially perpendicular to the axis of the insulated portion.

27) The method of claim 25, the method further comprising rotating the circuit breaker controller to induce the first motion to the mechanical member.

28) The method of claim 25, the method further comprising the first motion pivoting a link connected to the mechanical member to induce the second motion.

29) A monitoring system for a gas insulated circuit breaker, the system comprising:
a gas-filled interrupting chamber for receiving a circuit breaker;
a grounded insulating portion fluidly connected to the interrupting chamber; and
a monitoring system near the electrical ground, the monitoring system being in gas communication with the insulating portion.

30) The monitoring system of claim 30, the monitoring system comprising a sensor for measuring characteristics of the gas.

31) The monitoring system of claim 30, the monitoring system comprising an optical fiber extending through the insulating portion.

32) The monitoring system of claim 32, the optical fiber comprising one or more sensors in data communication with the monitoring system.
